(19) United States
(12) Patent Application Publication
(10) Pub. No.: US 2016/0245973 A1
(43) Pub. Date: Aug. 25, 2016

(54) LIGHT GUIDING ROD AND ILLUMINATION DEVICE INCLUDING THE SAME

(71) Applicant: Stanley Electric Co., Ltd., Tokyo (JP)

(72) Inventors: Kouichi Osaka, Tokyo (JP); Naoya Sone, Tokyo (JP); Tatsuya Sekiguchi, Tokyo (JP)

(21) Appl. No.: 15/051,268

(22) Filed: Feb. 23, 2016

(30) Foreign Application Priority Data
Feb. 24, 2015 (JP) 2015-033571

(51) Int. Cl. F21V 8/00

(52) U.S. Cl. CPC G02B 6/001

(57) ABSTRACT

A light guiding rod and an illumination device can facilitate the light distribution control in the width direction and can improve the light utilization efficiency. The light guiding rod can be configured to guide light emitted from a light source disposed to face to a longitudinal end face of the light guiding rod in a longitudinal direction. The light guiding rod can include a lens cut face having a plurality of lens cuts formed side by side along the longitudinal direction, and an emission face configured to allow the light to exit the light guiding rod therethrough. The light guiding rod can have a polygonal cross section perpendicular to the longitudinal direction and the polygonal cross section can have a plurality of paired sides facing to each other, and at least one of the paired sides can be a pair of the lens cut face and the emission face.

This application claims the priority benefit under 35 U.S.C. §119 of Japanese Patent Application No. 2015-033571 filed on Feb. 24, 2015, which is hereby incorporated in its entirety by reference.

### TECHNICAL FIELD

The presently disclosed subject matter relates to a light guiding rod configured to be illuminated with light from a light source, and an illumination device including the same.

### BACKGROUND ART

There are known conventional illumination devices, such as vehicle lighting fixtures, that include a light guiding rod that is capable of emitting light therealong, as those described in Japanese Patent No. 3334833 and Japanese Patent Application Laid-Open No. 2012-190762.

As illustrated in FIGS. 1A and 1B, this type of illumination device can be provided with an elongated light guiding rod and a light source, such as a light emitting diode, disposed to face to one longitudinal end face of the light guiding rod in its longitudinal direction. In general, such a light guiding rod can be formed to have a circular cross section and a plurality of lens cuts formed side by side along its longitudinal direction in a surface opposite to a light emission face.

With this configuration, when light is emitted from the light source to enter the light guiding rod through the longitudinal end face in the longitudinal direction, the light can be guided through the light guiding rod in the longitudinal direction while being internally reflected by the plurality of lens cuts, thereby exiting through the light emission face.

However, when the light guide rod is formed to have a simple circular cross section, the light distribution in the width direction perpendicular to its longitudinal direction (in the left-right direction in FIG. 1B) depends on the radius of curvature of the cross section, meaning that this configuration makes the light distribution control in the width direction difficult.

In the light guiding rod with the circular cross section, the light other than light directly exiting in the light distribution direction and light directed to the lens cuts (light incident on an outer peripheral surface other than the portion with diagonal lines in FIG. 1B) may be confined within the inside of the light guiding rod and difficult to exit to the outside, resulting in deterioration of the light utilization efficiency.

### SUMMARY

The presently disclosed subject matter was devised in view of these and other problems and features in association with the conventional art. According to an aspect of the presently disclosed subject matter a light guiding rod and an illumination device including the same can facilitate the light distribution control in the width direction perpendicular to the longitudinal direction and can improve the light utilization efficiency.

According to another aspect of the presently disclosed subject matter, a light guiding rod can be configured to guide light emitted from a light source disposed to face to a longitudinal end face of the light guiding rod in a longitudinal direction. The light guiding rod can be configured to include a lens cut face having a plurality of lens cuts formed side by side along the longitudinal direction, and an emission face configured to allow the light to exit the light guiding rod therethrough. The light guiding rod can be configured to have a polygonal cross section perpendicular to the longitudinal direction and the polygonal cross section can have a plurality of paired sides facing to each other, and at least one of the paired sides can be a pair of the lens cut face and the emission face.

According to still another aspect, the light guiding rod of the above-described aspect can be configured such that the plurality of lens cuts can be formed to be recessed with respect to an outer shape of the light guiding rod.

According to still another aspect, the light guiding rod of any one of the above-described aspects can be configured such that at least two of the paired sides can be pairs of the lens cut face and the emission face, and the lens cut faces can be disposed to be adjacent to each other and the emission faces can be disposed to be adjacent to each other.

According to still further another aspect, the light guiding rod of any one of the above-described aspects can be configured such that the cross section perpendicular to the longitudinal direction can be formed to a shape in which adjacent two sides are connected to each other via a chamfered face.

According to still another aspect of the presently disclosed subject matter, an illumination device can be configured to include the light guiding rod of any one of the aforementioned aspects, and the light source disposed to face to the longitudinal end face of the light guiding rod in the longitudinal direction,

According to the presently disclosed subject matter, the elongated light guiding rod can have the cross section formed in a polygonal shape having the plurality of paired faces facing to each other, and at least one of the paired faces includes the lens cut face having a plurality of lens cuts formed side by side along the longitudinal direction and the emission face allowing light to exit therethrough.

This configuration can facilitate the light distribution control in the width direction by adjusting the structure of the emission face (for example, making concave or convex) unlike the conventional light guiding rod having a circular cross section in which the widthwise light distribution depends on the radius of curvature of the circular cross section perpendicular to the longitudinal direction.

Furthermore, the light guiding rod with this configuration can increase the amount of emission light because the light other than the light directly exiting in the light distribution direction and the light directed to the lens cuts can be facilitated to be directed to the lens cuts and to the light distribution direction by the internal reflection.

Thus, the light guiding rod can facilitate the light distribution control in the width direction perpendicular to the longitudinal direction and can improve the light utilization efficiency.

### BRIEF DESCRIPTION OF DRAWINGS

These and other characteristics, features, and advantages of the presently disclosed subject matter will become clear from the following description with reference to the accompanying drawings, wherein:

FIGS. 1A and 1B are diagrams illustrating the conventional illumination device and light guiding rod;

FIG. 2 is a perspective view of essential components of an illumination device made in accordance with principles of the presently disclosed subject matter;

FIG. 3 is an enlarged perspective view showing the encircled part II in FIG. 2;

FIG. 4 is a cross section of a light guiding rod taken along line III-III in FIG. 2;

FIG. 5 is a table showing the analysis results;

FIG. 6 is a perspective view of a first modified example of the illumination device in the exemplary embodiment;

FIG. 7 is an enlarged perspective view showing the encircled part VI in FIG. 6;

FIG. 8 is a cross-sectional view of a light guiding rod taken along line VII-VII in FIG. 6; and

FIG. 9 is a cross-sectional view of a second modified example of the illumination device in the exemplary embodiment.

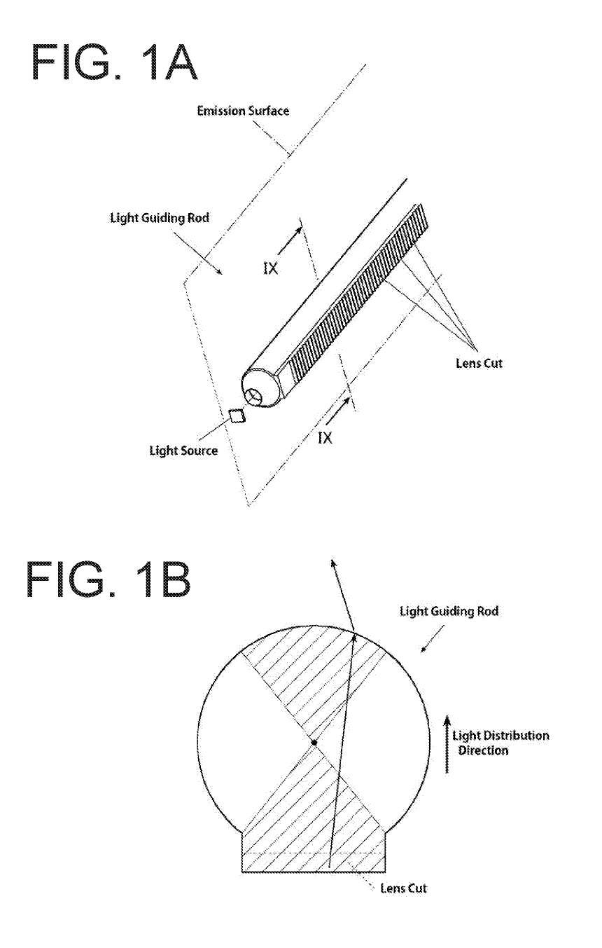

### DESCRIPTION OF EXEMPLARY EMBODIMENTS

A description will now be made below to vehicle lights of the presently disclosed subject matter with reference to the accompanying drawings in accordance with exemplary embodiments.

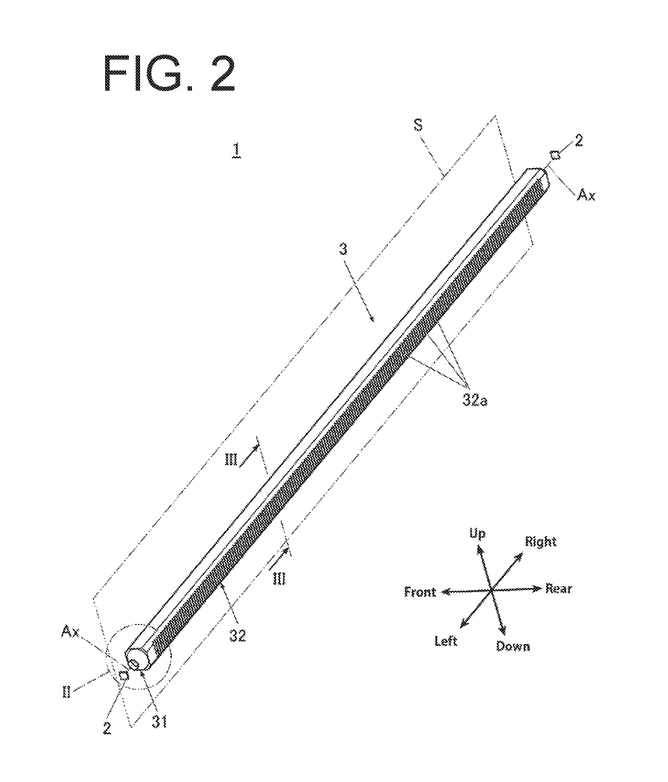

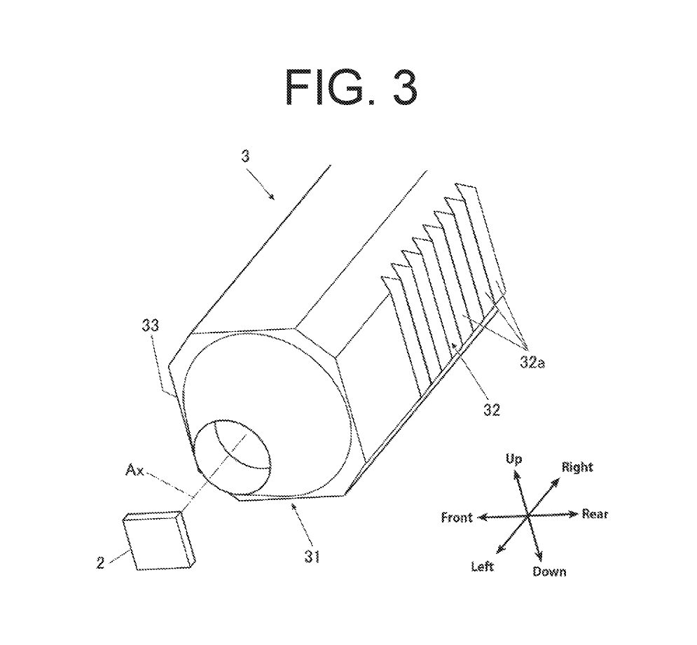

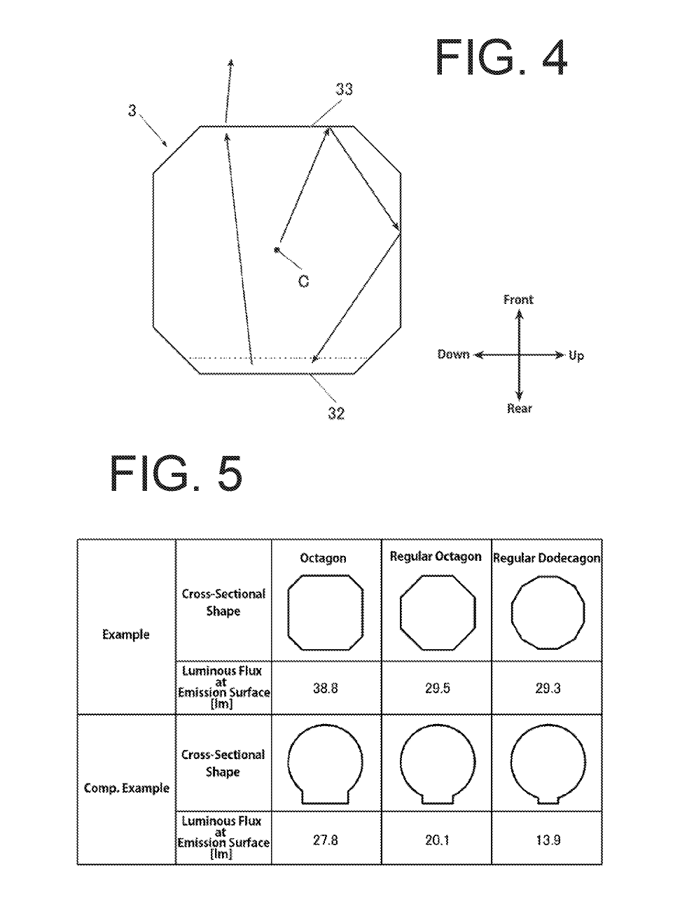

FIG. 2 is a perspective view of essential components of an illumination device 1 made in accordance with the principles of the presently disclosed subject matter. FIG. 3 is an enlarged perspective view showing the encircled part II in FIG. 2, and FIG. 4 is a cross section of a light guiding rod 3 of the illumination device 1 taken along line III-III in FIG. 2.

As illustrated in FIGS. 2 and 3, the illumination device I can include two light emitting diodes (LEDs) 2 serving as light sources and the light guiding rod 3, and configured to project light toward an emission surface S.

The two LEDs 2 as a light source of the illumination device 1 can be disposed such that their emission faces face to respective longitudinal right and left end faces of the light guiding rod 3. Each of the LEDs 2 can have an optical axis Ax in a left-right direction to emit light substantially radially around the optical axis Ax toward the respective right and left end faces of the light guiding rod 3.

The light guiding rod 3 can be configured to guide the light from the two LEDs 2 and project light. The light guiding rod 3 can be formed in an elongated linear rod shape and disposed to extend in the right-left direction in the drawing.

The light guiding rod 3 can have incident portion 31 at each of the right and left end faces to allow the light from the respective LEDs 2 to enter the light guiding rod 3. (Note that FIGS. 2 and 3 show only left one of them.) Each of the incident portions 31 can be formed to project leftward or rightward in an axial-symmetric conical shape while having a recessed end portion. The axis of symmetry thereof is coincident with the optical axis Ax of the LED 2. In this manner, the LED 2 can be disposed to face to the incident portion 31.

The light guiding rod 3 can have a polygonal cross section perpendicular to the left-right direction. The polygonal cross section can include a plurality of paired sides opposite to each other. In the illustrated exemplary embodiment, the cross section can be formed such that a square having four sides serves as a basic shape and adjacent two sides are connected with a chamfered face to thereby form an octagon. The center C of the cross section of the light guiding rod 3 can be located on the optical axes AX of the respective LEDs 2.

Note that the “cross section” of the light guiding rod herein means the cross section perpendicular to the left-right direction (or the longitudinal direction of the light guiding rod) unless otherwise specified.

The light guiding rod 3 can have a rear face serving as a lens cut face 32 with a plurality of lens cuts 32a formed therein side by side along the left-right direction substantially entirely, as illustrated in FIGS. 2 and 3. Here, the lens cuts 32a can be formed in the lens cut face 32 to be recessed with respect to the outer shape of the light guiding rod 3.

The light guiding lens 3 can have a front face serving as an emission face 33 configured to allow the light to exit the light guiding rod 3 therethrough and face to the emission surface S. The emission face 33 can be formed to face to the lens cut face 32 in the cross section of the light guiding rod 3 and have the same vertical width as that of the lens cut face 32 so that the emission face 33 allows the light having been internally reflected by the lens cut face to exit outside. Note that the emission face 33 may be formed to be convex or recessed depending on the vertical width of the desired emission surface S, or to include a lens cut or lens cuts for diffusion formed therein.

Among the plurality of paired sides facing to each other in the cross section of the light guiding rod 3, at least one of the paired sides should be a combination of the lens cut surface 32 and the emission face 33. Accordingly, there can be a plurality of paired sides as in the later described modified examples.

A description will now be given of the analysis results regarding the comparison between the light guiding rod 3 and a light guiding rod having a circular cross section in terms of the amount of light emission.

In the analysis, the cross sectional shape of the light guiding rod 3 was changed among an octagon, a regular octagon, and a regular dodecagon, and the amount of emission light (luminous flux) that reached the emission surface S from the light guiding rod 3 was calculated. Then, those amounts from the light guiding rods 3 with various cross sections were compared with that of the light guiding rod having the circular cross section while the width of the lens cut face was the same. Here, the input luminous flux from the respective LEDs 2 was 100 lm.

FIG. 5 is a table showing the analysis results.

As shown in the table, it is clear that all the cases of the octagonal, regular octagonal, and regular dodecagonal shapes of the light guiding rods 3 showed the amounts of emission light (luminous flux) more than the case of the circular shape of the light guiding rod. Furthermore, the rate of increase of the amount of emission light is increased as the cross section of the light guiding rod 3 is closer to the circular shape.

Furthermore, the analysis showed that there is a correlation between the amount of emission light and the width of the lens cut face 32. Specifically, the wider width could provide the more amount of emission light.

As described, the present exemplary embodiment can be configured to have the polygonal cross section perpendicular to the longitudinal direction of the elongated light guiding rod 3 and the polygonal cross section can have the plurality of paired sides facing to each other, and at least one of the paired sides can be the pair of the lens cut face 32 and the emission face 33.

This configuration can facilitate the light distribution control in the width direction by adjusting the structure of the emission face 33 (for example, making concave or convex) unlike the conventional light guiding rod having a circular cross section in which the widthwise light distribution depends on the radius of curvature of the circular cross section perpendicular to the longitudinal direction.

Furthermore, the light guiding rod 3 with this configuration can increase the amount of emission light because the light other than the light directly exiting in the light distribution direction (forward) and the light directed to the lens cuts 32a can be facilitated to be directed to the lens cuts 32a and to the light distribution direction by the internal reflection.

Thus, the light guiding rod 3 can facilitate the light distribution control in the width direction perpendicular to the longitudinal direction and can improve the light utilization efficiency.

Since the plurality of lens cuts 32a can be formed to be recessed with respect to the outer shape of the light guiding rod 3, the light guiding rod 3 can be made compact when compared with the case where the lens cuts are formed to be convex, and the members for accommodating the light guiding rod 3 can be miniaturized accordingly.

Furthermore, since the cross section of the light guiding rod 3 can be formed to have chamfered portions connecting the adjacent two sides, the chambered portions can serve to internally reflect the light to be directed to the lens cuts 32a or to the light distribution direction more effectively. Furthermore, the chamfered portions can facilitate the adjustment of the widths of the lens cut face 32 and the emission face 33.

Next, a description will now be given of a first modified example of the above-mentioned exemplary embodiment. In the description, the same or similar components of the first modified example as those of the above-mentioned exemplary embodiment will be denoted by the same reference numerals, and descriptions thereof will be appropriately omitted here.

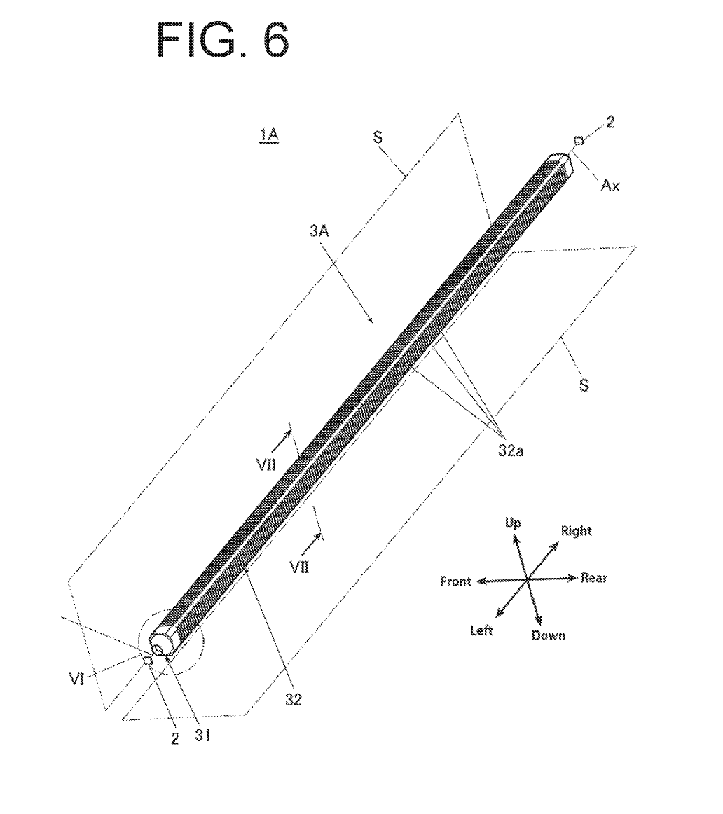

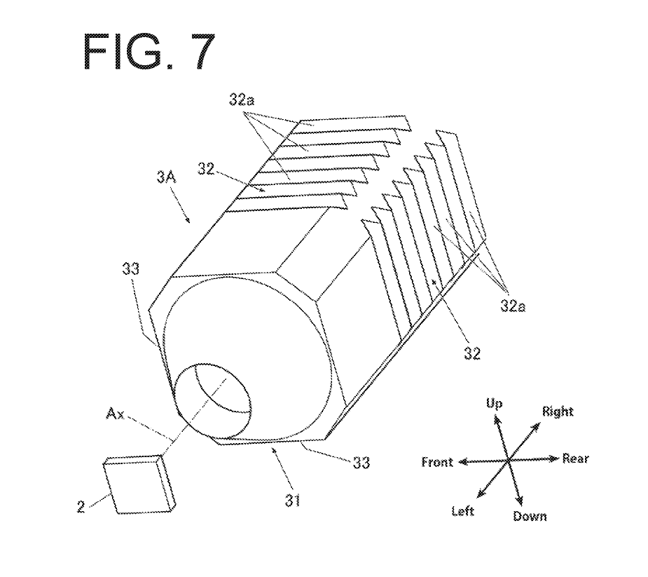

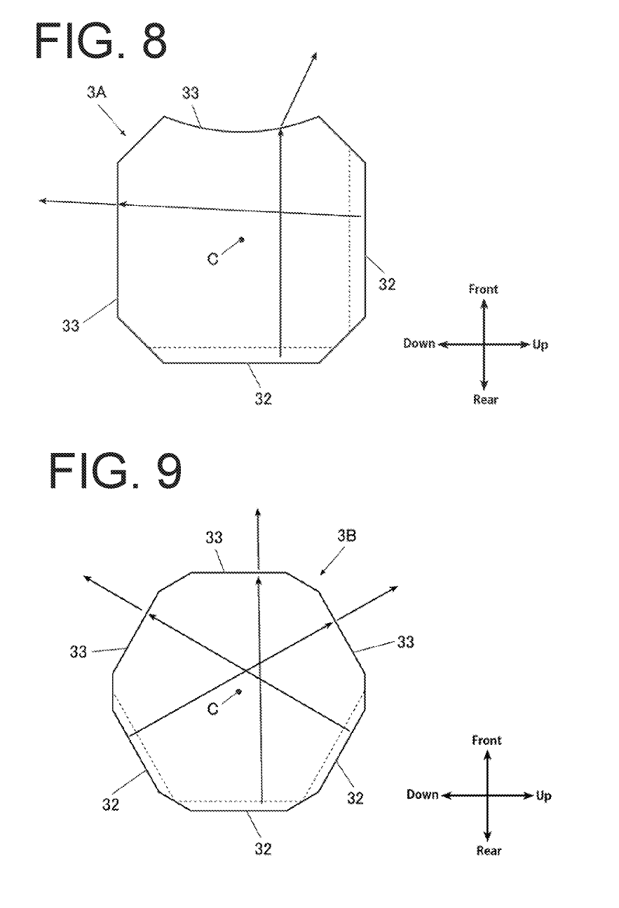

FIG. 6 is a perspective view of essential parts of an illumination device 1A of the first modified example. FIG. 7 is an enlarged perspective view showing the encircled part VI in FIG. 6, and FIG. 8 is a cross-sectional view of a light guiding rod 3A of the illumination device 1A taken along line VII-VII in FIG. 6.

As illustrated in FIGS. 6 and 7, the illumination device IA can be configured to project light toward two emission surfaces S in front thereof and therebelow. The illumination device IA can include the light guiding rod 3A in place of the light guiding rod 3 of the above-mentioned exemplary embodiment.

The light guiding rod 3A is different from the light guiding rod 3 of the above-mentioned exemplary embodiment in that the numbers of the lens cut face 32 and the emission face 33 are each two corresponding to the two light distribution directions.

Specifically, as illustrated in FIG. 8, the light guiding rod 3A can include two lens cut faces 32 formed in the rear face and upper face adjacent to each other via a chamfered face, with the lens cut faces 32 including a plurality of lens cuts 32a formed therein as illustrated in FIGS. 6 and 7.

Furthermore, the light guiding rod 3A can include two emission faces 33 formed in the front face and lower face facing to the rear face and the upper face, respectively. The emission faces 33 can be configured to face to the respective two emission surfaces S so that they can project light from the corresponding lens cut faces 32. Among them, the emission face 33 in the front face of the light guiding rod 3A can have a recessed cross section so as to diffuse the projected light in a vertical direction.

As described above, the first modified example can easily achieve the light distribution in different two directions (forward and downward in this modified example) as well as the same advantageous effects of the above-mentioned exemplary embodiment.

Next, a description will now be given of a second modified example of the above-mentioned exemplary embodiment. In the description, the same or similar components of the second modified example as those of the above-mentioned exemplary embodiment will be denoted by the same reference numerals, and descriptions thereof will be appropriately omitted here.

FIG. 9 is a cross-sectional view of a light guiding rod 3B of the second modified example.

As illustrated, the light guiding rod 3B can include a cross section formed such that a regular hexagon serves as a basic shape and adjacent two sides are connected with a chamfered face to thereby form a dodecagon.

In the light guiding rod 3B, three faces, i.e., a rear face, obliquely upper rear face, and obliquely lower rear face adjacent to each other via a chamfered face can serve as the lens cut faces 32. Furthermore, three faces, i.e., a front face, obliquely lower front face, and obliquely upper front face facing to the respective three lens cut faces 32 can serve as the emission faces 33.

As described above, the second modified example can easily achieve the light distribution in different three directions (forward, obliquely upper forward, and obliquely lower forward in this modified example) as well as the same advantageous effects of the above-mentioned exemplary embodiment.

Furthermore, when the light guiding rod 3B can have the paired lens cut faces 32 and emission faces 33 to correspond to a desired light distribution direction, multidirectional light distribution can be easily achieved.

Embodiments to which the presently disclosed subject matter is applicable are not limited to the above-described exemplary embodiment, and can be appropriately modified within the scope of the presently disclosed subject matter.

For example, although the above-mentioned embodiment and modified examples have dealt with the cases in which the light guiding rod is linearly formed, the light guiding rod may be formed in a curved manner as long as the light guiding rod can guide light in the lengthwise direction thereof.

The light guiding rod and the illumination device made in accordance with the principles of the presently disclosed subject matter can be applied to a read-out light source for a scanner and a copying machine, a multidirectional light-emitting device, etc. in addition to vehicle lighting fixtures.

It will be apparent to those skilled in the art that various modifications and variations can be made in the presently disclosed subject matter without departing from the spirit or scope of the presently disclosed subject matter. Thus, it is intended that the presently disclosed subject matter cover the modifications and variations of the presently disclosed subject matter provided they come within the scope of the appended claims and their equivalents. All related art references described above are hereby incorporated in their entirety by reference.

What is claimed is:

1. A light guiding rod that has a longitudinal end face and is configured to guide light emitted from a light source disposed to face to the longitudinal end face of the light guiding rod in a longitudinal direction, the light guiding rod comprising:
a lens cut face haying a plurality of lens cuts formed side by side along the longitudinal direction; and
an emission face configured to allow the light to exit the light guiding rod therethrough, wherein
the light guiding rod has a polygonal cross section perpendicular to the longitudinal direction and
the polygonal cross section has a plurality of paired sides facing to each other, and at least one of the paired sides is a pair of the lens cut face and the emission face.

2. The light guiding rod according to claim 1, wherein the plurality of lens cuts are formed to be recessed with respect to an outer shape of the light guiding rod.

3. The light guiding rod according to claim 1, wherein
at least two of the paired sides are pairs of the lens cut face and the emission face, and
the lens cut faces are disposed to be adjacent to each other and the emission faces are disposed to be adjacent to each other.

4. The light guiding rod according to claim 2, wherein
at least two of the paired sides are pairs of the lens cut face and the emission face, and
the lens cut faces are disposed to be adjacent to each other and the emission faces are disposed to be adjacent to each other.

5. The light guiding rod according to claim 1, wherein the cross section perpendicular to the longitudinal direction is formed to a shape in which adjacent two sides are connected to each other via a chamfered face.

6. The light guiding rod according to claim 2, wherein the cross section perpendicular to the longitudinal direction is formed to a shape in which adjacent two sides are connected to each other via a chamfered face.

7. The light guiding rod according to claim 3, wherein the cross section perpendicular to the longitudinal direction is formed to a shape in which adjacent two sides are connected to each other via a chamfered face.

8. The light guiding rod according to claim 4, wherein the cross section perpendicular to the longitudinal direction is formed to a shape in which adjacent two sides are connected to each other via a chamfered face.

9. An illumination device comprising:
a light guiding rod having a longitudinal end face; and
a light source disposed to face to the longitudinal end face of the light guiding rod in a longitudinal direction thereof, wherein
the light guiding rod is configured to guide light emitted from the light source in the longitudinal direction, the light guiding rod comprising: a lens cut face having a plurality of lens cuts formed side by side along the longitudinal direction, and an emission face configured to allow the light to exit the light guiding rod therethrough,
the light guiding rod has a polygonal cross section perpendicular to the longitudinal direction and
the polygonal cross section has a plurality of paired sides facing to each other, and at least one of the paired sides is a pair of the lens cut face and the emission face.

10. The illumination device according to claim 9, wherein the plurality of lens cuts are formed to be recessed with respect to an outer shape of the light guiding rod.

11. The illumination device according to claim 9, wherein
at least two of the paired sides are pairs of the lens cut face and the emission face, and
the lens cut faces are disposed to be adjacent to each other and the emission faces are disposed to be adjacent to each other.

12. The illumination device according to claim 10, wherein
at least two of the paired sides are pairs of the lens cut face and the emission face, and
the lens cut faces are disposed to be adjacent to each other and the emission faces are disposed to be adjacent to each other.

13. The illumination device according to claim 9, wherein the cross section perpendicular to the longitudinal direction is formed to a shape in which adjacent two sides are connected to each other via a chamfered face.

14. The illumination device according to claim 10, wherein the cross section perpendicular to the longitudinal direction is formed to a shape in which adjacent two sides are connected to each other via a chamfered face.

15. The illumination device according to claim 11, wherein the cross section perpendicular to the longitudinal direction is formed to a shape in which adjacent two sides are connected to each other via a chamfered face.

16. The illumination device according to claim 12, wherein the cross section perpendicular to the longitudinal direction is formed to a shape in which adjacent two sides are connected to each other via a chamfered face.
